(19) United States
(12) Patent Application Publication
(10) Pub. No.: US 2015/0334190 A1
(43) Pub. Date: Nov. 19, 2015

(54) Cloud Side Application

(71) Applicant: Yoram Bucks, Rishon Lezion (IL)

(72) Inventor: Yoram Bucks, Rishon Lezion (IL)

(21) Appl. No.: 14/276,815

(22) Filed: May 13, 2014

(51) Int. Cl. H04L 29/08

(52) U.S. Cl. CPC H04L 67/141; H04L 67/10

(57) ABSTRACT

Cloud Side Application (CSA) is an environment that allows programmers to develop, to host and to run solutions on the server side; CSA runs the solution.

At run time CSA implements the user interface graphically on the client device and raises events on the server side.

CSA can run the solution on any platform.

### CROSS-REFERENCE TO RELATED APPLICATIONS

Not Applicable.

### STATEMENT REGARDING FEDERALLY SPONSORED RESEARCH OR DEVELOPMENT

Not Applicable.

### COMPUTER PROGRAM LISTING COMPACT DISC APPENDIX (txt FILES)

The file “ATML_Net.txt” is the content of the source files of an application that implements CSA SERVER; it is VB.Net application that can be open with Visual Studio 2010 and compiled as DLL.

The file “SampleSolution.txt” is the content of the source files of a simple solution that developed using ATML.Net.DLL; it is a web project that can be open with Visual Studio 2010.

The file “ATML_Broeser_WPF.txt” is the content of the source files of a CSA DRIVER (CLIENT) for windows; it is a WPF project that can be open with Visual Studio 2010.

The File “ATML_Browser.txt” is the content of the source files of a CSA DRIVER (CLIENT) for Android; it is an Android framework project that can be open with Eclipse.

The file “CRM.txt” is the content of the source files of an example of a solution with database; it is a web project that can be open with Visual Studio 2010.

### BACKGROUND OF THE INVENTION

The invention relates to developing and running multiuser software application (SOLUTION).

A SOLUTION is an application that shares data among users, where each user runs the user interface from a personal device (CLIENT) and the device communicates with an application server (SERVER).

For creating a SOLUTION programmers develop a user interface program that initiates requests to a separated program that runs on a SERVER.

One good example is developing a user interface environment using HTML+Java Script; and a server application that runs a Microsoft ASP.NET program. The user interface initiates requests by posting forms or by running a Java Script code; the SERVER returns responses with HTML or with XML and the CLIENT updates the user interface.

Other example is developing a user interface using a native environment like Android framework and to initiates requests to a SERVER that runs a Microsoft.NET program.

### BRIEF SUMMARY OF THE INVENTION

Cloud Side Application (CSA) is an environment that allows programmers to develop a SOLUTION as one program that includes user interface and server side.

With CSA the user interface is not related to a specific platform or operating system.

With CSA the SOLUTION is hosted on the SERVER.

CSA can run the SOLUTION from any platform or operating system.

At run time CSA implements the user interface graphically and natively on the CLIENT and raises events on the SERVER.

With CSA the programmer develops with a single programming language; it can be any language.

### BRIEF DESCRIPTION OF THE SEVERAL VIEWS OF THE DRAWING

FIG. 1 is an example of a simple solution.

FIG. 2 is a diagram of a process when CSA runs a new session.

FIG. 3 describes how SERVER builds response to the CLIENT while running a code from the simple solution.

FIG. 4 is a screenshot from the simple solution.

FIG. 5 is a diagram of how CSA runs a session.

FIG. 6 shows an example content of a request from the simple solution.

FIG. 7 describes how the server gets the request (FIG. 6), raises events and prepares a response.

FIG. 8 shows an example of using the “Timer” feature.

FIG. 9 is the CRM database diagram.

FIG. 10 is the Customer_v view from the CRM database

FIG. 11 is the CustomerActivity_v view from the CRM database.

FIG. 12 is the CustomerRetrievalPage class from the CRM solution.

FIG. 13 is a screenshot of the CustomerRetrievalPage class.

### DETAILED DESCRIPTION OF THE INVENTION

Cloud Side Application (CSA) is an environment that allows programmers to develop a SOLUTION as one program that includes user interface and server side.

With CSA the user interface is not related to a specific platform or operating system.

With CSA the SOLUTION is hosted on the SERVER.

CSA can run the SOLUTION from any platform or operating system.

At run time CSA implements the user interface graphically and natively on the CLIENT and raises events on the SERVER.

With CSA the programmer develops with a single programming language; it can be any language.

The CLIENT runs a SOLUTION by using CSA driver (CSA DRIVER) there should be a different CSA DRIVER for each platform.

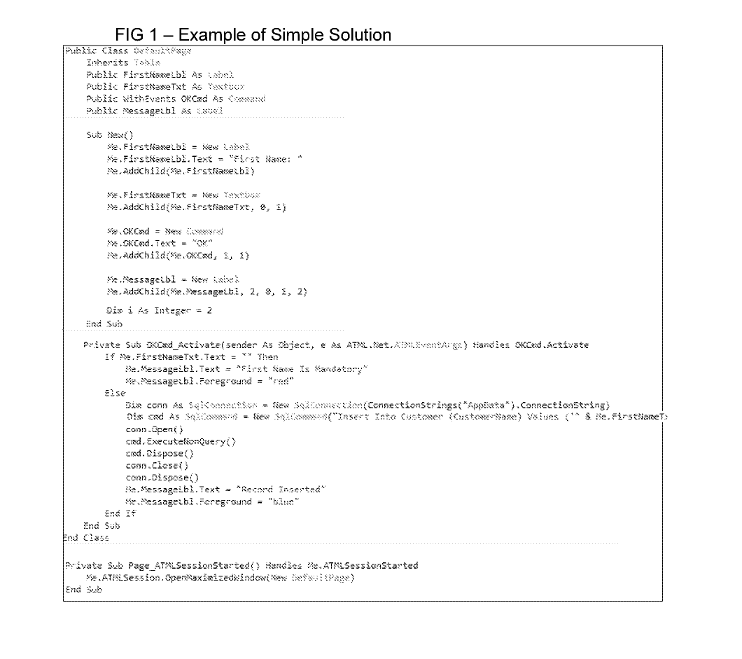

FIG. 1 shows an example of a simple SOLUTION; the SOLUTION is hosted by the SERVER.

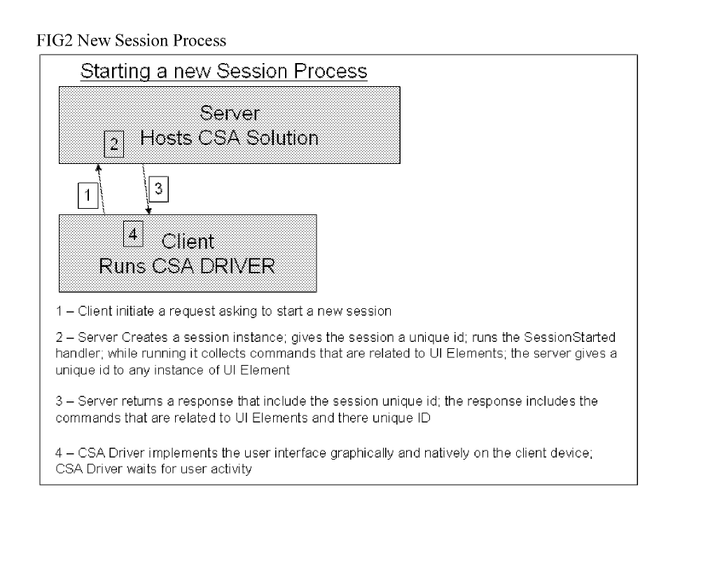

FIG. 2 shows the process that runs when CLIENT starts a new session of the SOLUTION.

CSA DRIVER sends a request to the server and asks to start a new session.

The SERVER creates a session instance; the SERVER gives the session a unique id; the SERVER runs the SessionStarted handler; while running it collects commands that are related to UI Elements; the SERVER gives a unique id to any instance of UI Element.

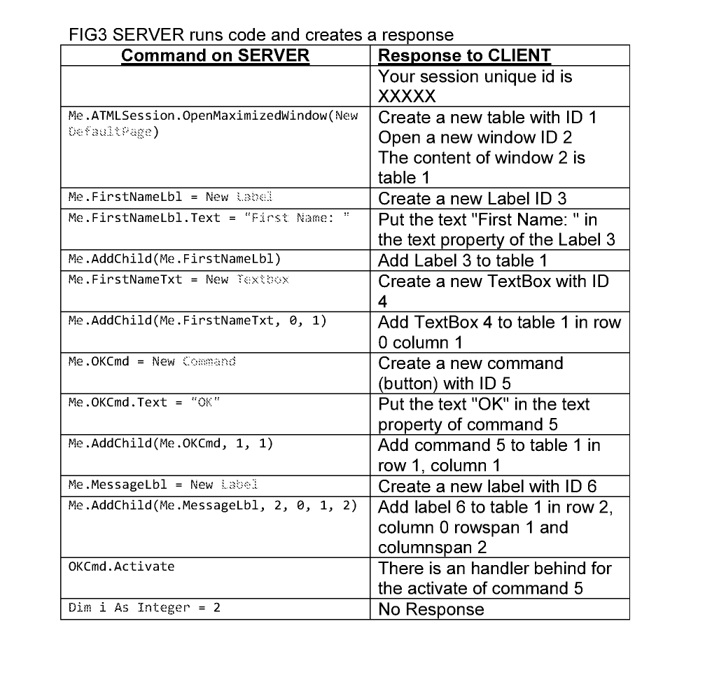

FIG. 3 shows an example of how does the SERVER build a response while running the SessionStarted handler on FIG. 1.

The SERVER does not send information to the CLIENT about commands that are not related to UI Elements.

The SERVER returns a response that includes the session unique id; the response includes the commands that are related to UI Elements and there unique id.

CSA DRIVER implements the user interface graphically and natively on the client device; CSA DRIVER waits for user activity.

FIG. 4 shows the screenshot that CSA DRIVER displays on the CLIENT device after starting a new session of the sample SOLUTION (FIG. 1).

The SERVER stores the instance of the session and the instances of the UI Elements.

While running the session CSA repeats a loop of operations as described in FIG. 5.

CSA DRIVER waits for user activity; for example user can click on any UI Element or put text on a TextBox.

CSA Driver stores the information of each activity with the UI Element unique id and the activity content.

When CSA DRIVER sees that the user activity required raising an event on the solution it initiates a request. For example if the user put text on a TextBox and the programmer defined on the SOLUTION a handler for the OnChange event of that TextBox then CSA DRIVER initiates a request otherwise it contuse storing the user activities.

The request start with the session unique id and it includes the information about the user activities.

The server gets the existing instance of the session and for each user activity it gets the existing instance of the UI Element and updates it and raises events according to the user activity.

While running the handlers (the handlers that the programmer defined on the SOLUTION) the server collects commands that are related to UI Elements.

The server returns a response to the CLIENT that includes the commands that are related to UI Elements.

CSA DRIVER gets the response and updates the user interface and returns to wait for user activity.

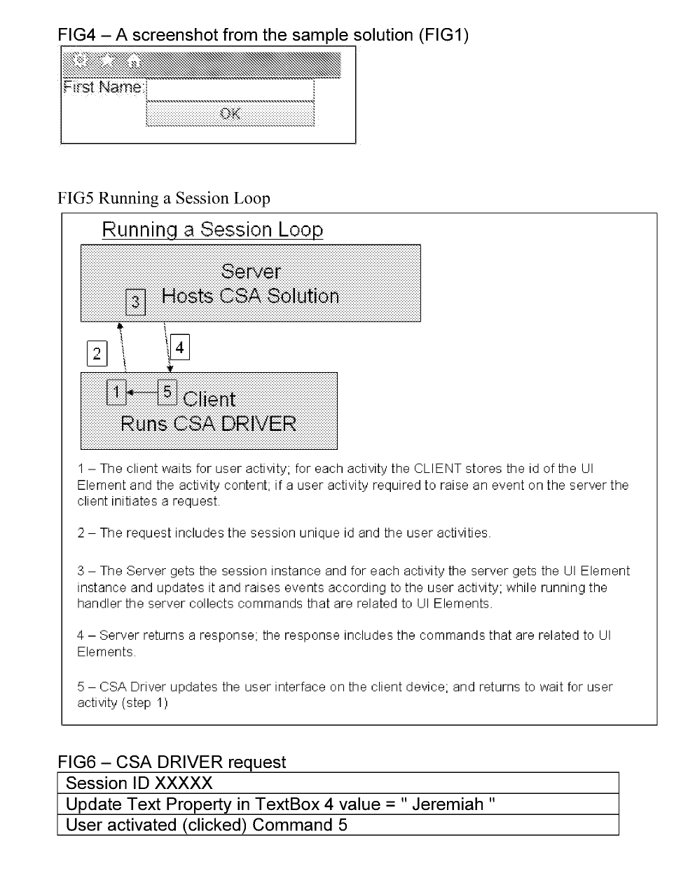

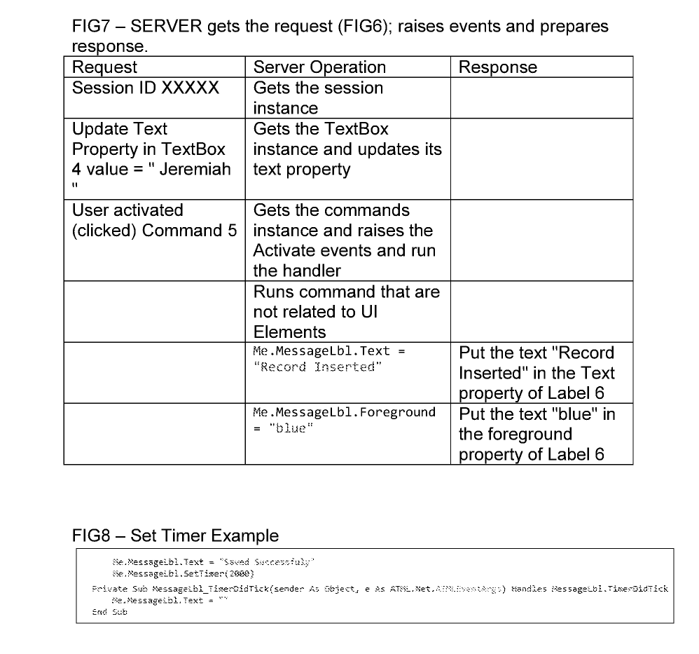

For example, if in FIG. 3 the user types the text “Jeremiah” on the TextBox and clicks the OK button. CSA DRIVER initiates a request with the information on FIG. 6, the SERVER does the operations that described in FIG. 7; the CLIENT receives the response and updates the user interface and returns to wait for user activity.

### Primitive Elements

CSA DRIVER should support only few basic UI Elements (PRIMITIVE ELEMENTS).

Example for set of PRIMITIVE ELEMENTS: Table, Check box, Button, File Picker, Holder, Image, Label, Radio Button, Scrollable and Text box.

The other UI Elements only inherits and use PRIMITIVE ELEMENTS.

In that way most of the UI Elements are server side only and CSA allows programmers to develop custom UI Elements with there solutions.

For example a “Date Picker” UI Element inherits from TABLE; in the table there are Text Box and a Button. When the user clicks the button a “Calendar” UI Element is shown, “Calendar” is also inherits from TABLE with many Labels inside it; and buttons to select month and year.

### Additional Commands

CSA allows the programmer to send additional commands to the client. The commands with required parameters are sent with the response and CSA DRIVER executes the command on the client device.

For example “Open URL” command with the URL as parameter—CMS DRIVER should open the URL with the default program as defines on the client device.

Other example of commands: “OpenWindow”, “OpenDialogWindow”, “Print URL”,

### Keeping Session Alive

Every 60 seconds CSA DRIVER initiates an empty request and gets an empty response from the SERVER in order to keep the session alive.

### Memory Release

CSA (SERVER) identifies UI Element that should be released from memory. UI Element should be release when it is a content of a window that has been closed or if it removed from its parent UI Element.

When CSA identifies that a UI Element needs to be release it send a release command with the ID of the UI Element and release it from the memory of the SERVER.

CSA DRIVER gets the release command and releases the UI Element from the CLIENT memory.

The programmer can prevent the release process by putting the value True on the “IsAutoReleasePrevented” property of the UI Element.

The programmer can also release any UI Element manually by invoking the Release method of the UI Element.

### StyleCopier Method

The purpose of the StyleCopier method is to save communication volume and by that to increase performance.

The programmer can copy the style from one UI Elements to another.

Style is all the properties of the UI Elements that related to the appearance of the UI Element like properties that related to size, font, and colors.

Instead of setting the properties one by one, the programmer can invoke the StyleCopier method with two parameters the source UI Element and the target UI Element.

CSA SERVER set the values of the appearance's properties of the target UI Element with the value of the same property in the source UI Element.

CSA SERVER does not send to the CLIENT information about each property in separated. The SERVER sends to the CLIENT the StyleCopier command with the unique id of the source UI Element and the unique id of the target UI Element. CSA DRIVER gets the command and set the same properties on the CLIENT.

### SetTimer Command

The purpose of the SetTimer command is to run user interface operations in delay.

For example the programmer wants to display a message and to hide the message after 2 seconds.

Each UI Elements can raise an onTimer event.

For using the SetTimer the programmer needs to invoke the SetTimer method of the UI Element with interval parameter and to add handler for the TimerDidTick as shown in FIG. 8.

When CSA DRIVER sees the SetTimer command it initiates a request after the time interval elapses and the SERVER raises the TimerDidTick event on the SOLUTION.

### Example of CSA Server Application

The file “ATML_Net.txt” includes source files of an example of CSA server. It compiled as class library (DLL).

Programmers can use it by creating a web site with a reference to ATML.Net.DLL.

With this example a solution is a web site (ASP.NET) that can be hosted on standard IIS server. The solution receives http requests and responses with XML; the PendingCommands variable gathers the response commands.

The class ASPPage (“ATML.Net\Base\ASPPage.vb” in “ATML_Net.txt”) is the bridge for the IIS; it inherits the page class of ASP.NET (System.Web.UI.Page), The “PreRender” handler analyses the request and builds the response.

There are requests for special purposes like “BinaryData”, “EpmtyResponse”, and “Systemlmage”. I will describe those purposes latter. When it is a standard request the program continues and analyses the commands on the request (line 382 in ATML_Net.txt).

With this example the commands on the request are pairs of key/value that can be on the request header or in the posted data; each command starts with the value “Command Start” and ends with the value “Command End”, and in between there are the command name and the required parameters.

When the program finds the “Command End” value it sends it to be executed with the “ExecClientCommand” function.

A request for a new session starts with the “SessionStart” command. The program creates a new instance of ATMLSession class (base\ATMLSession.vb in “ATML_Net.txt”) this instance represents the session; it lives as long the session lives; it stores the objects that the programmer creates. The session gets a unique id; the ATMLSession is stored under the ASP Session under the session unique id key; the session unique id is sent to the client.

All the other CLIENT standard requests (beside SessionStart) begin with the “ExistingSession” Command and contain the session id. The program gets the ATMLSession instance from the ASP Session.

When the session starts the program raises the ATMLSessionStrted event. The programmer should create a handler for the event.

FIG. 1 contains a sample of a solution (the ATM LSessionStarted handler on the end); the first instruction on the sample solution is to create a new instance of the DefaultPage class. The DefaultPage class inherits from Table class which is a CSA UI Elements (ATML.Net\PrimitiveControls\Table\Table.vb in “ATML_Net.txt”).

The table class inherits from ATMLGroupControl class that inherits from ATMLControl class that inherits from ATMLObject class.

Any CSA UI Element eventually inherits from ATMLObject class; it means that for each new instance of a UI Elements invokes the constructor of ATMLObject; it gives a unique id to the instance and stores it on the ATMLSession under a dictionary; it sends to the CLIENT a command “ATML New Object” with the id and the type of the object.

Then the constructor of the DefaultPage class invoked (FIG. 1). With the constructor of the DefaultPage the program builds and manipulates some additional UI Elements. Each command that related to UI Element adds content to the response (by adding command to the PendingCommands). For example the command “Me.FirstName.Tex=“First Name:”” adds a command called “ATML Property Set” with the relevant parameters (ATML.Net\PrimitiveControls\Label.vb in “ATML_Net.txt” line 11029 and ATML.Net\Base\ATMLObject.vb line 848 in ATML_Net.txt).

In the defaultPage class the programmer adds a handler for the Activate event of OKCmd; the handler existence information is also sent to the CLIENT (on ATML.Net\PrimitiveControls\Command.vb line 10711 in ATML_Net.txt).

After getting the response for a new session request the CLIENT should implement the UI and display a window with label, textbox and a button; the CLIENT waits to the user activity.

If the user fills “Joens” on the textbox and clicks on the button the CLIENT should initiate a STANDARD REQUEST with commands.

The first command is “ExistingSession” with the session unique id; the program gets the instance of the ATMLSession (ASPPage.vb line 491 in ATML_Net.txt); the next command is “PropertyChange” with the unique id of the textbox, the property name “Text” and the value “Joens”; the program find the textbox instance (ASPPage.vb line 513 in ATML_Net.txt) and updates its text property (ATML.Net\PrimitiveControls\Textbox.vb in line 11468 in ATML_Net.txt); the next command is “CommandActivated” with unique id of the Command (button), the program gets the instance of the command (ASPPage.vb line 494 in ATML_Net.txt) and raises the “Activate” event; it runs the programmer handler (FIG. 1). Again all the commands that related to UI Elements add content to the response, the CLIENT updates the UI, waits for user activity.

The program includes support on some additional commands like “OpenWindow”, “ShowURL” and “PrintURL”.

With this example the only UI Elements that communicates directly with the CLIENT are: Table, Checkbox, Command, FilePicker, Holder, Image, Label, RadioButton, Scrollable and Textbox (all those elements are under the ATML.Net\PrimitiveControls). Those UI Elements called primitive elements.

This means that CSA DRIVER needs to support only primitive elements.

The other UI Elements on this example that some of them are very complex are only inheriting and/or using primitive elements.

That demonstrates how any programmer can develop UI Elements on the server side alone.

There are requests other the STANDARD REQUEST. “FilePickerBinaryData” request uses for uploading file with the FilePicker UI Element.

“EmptyResponse” meant to response for keeping alive requests.

“Systemlmage” requests are used for downloading Images that are stored with the ATML.Net.DLL.

### Example of CLIENT DRIVER

The file “ATML_Broeser_WPF.txt” includes source files of an example of a CSA DRIVER; it compiled as a program (EXE) that can run a SOLUTION that developed with ASP.Net.DLL; the SOLUTION is installed on a server and has a URL.

The URL can be typed by the user or it can be a parameter with the command line.

A session starts with on the Go function (ATML Broeser WPF\MainWindow.xaml.vb line 484 in ATML_Broeser_WPF.txt); it initiates a new instance of the MainClass (ATML Broeser WPF\General\MainClass.vb); this instance represents the session on the CLIENT and it lives as long the session lives; it stores the session variables and the UI Elements.

The PendingCommands variable stores the commands that need to be sent on the next request.

The Go function initiates a request with a single command “ATML Session”, “New” which is the syntax of a SessionStart command. The function MakeRequest on the MainClass initiates a STANDARD REQUEST; it posts the commands that are stored on the PendingCommands variable; it sends a request and gets a response from the SERVER; the response is in a form of XML (MainClass.bv line 4137 in ATML_Broeser_WPF.txt); the program parse the XML and executes each command with the ExecuteCommand function (MainClass.vb line 4181 in ATML_Broeser_WPF.txt).

The first command is always the SessionID command with the session unique id as parameter; the program store the unique id within a variable and prepare the first Command to be sent with the next request (“ATML Session” with the session unique id).

The NewObject command means to create a new UI Element; the command includes the type of the required UI Element and its unique id; the program creates a new instance of the specific type and store it on the ATMLObjects dictionary under its unique id; with each UI Element the program initiates an equivalent instances of WPF element; for example the constructor of ATMLLabel creates WPF Border, and WPF TextBlock (ATML Broeser WPF\ATMLObjects\ATMLLabel.vb line 1254 in ATML_Broeser_WPF.txt).

The other commands that related to the UI Elements includes the unique id of the element; the program gets the unique id; it gets the UI Element instance from the ATMLObjects variable; it updates the UI Element and the equivalent WPF elements according to the command.

The OpenWindow, Open Maximized Window and Open Dialog Window commands means that the program should open a window and displays the content of a UI Element in it; the command includes the unique id of the required UI Element; The program initiates a WPF window and puts the WPF element of the required UI Element as the window content.

Note that the UI Elements built as a tree where there are children for Table, Holder and Scrollable and when a window display the content of a UI Element it displays the tree under it as well.

The program listen to the user activity by adding handlers to the WPF elements; and when the user do something the WPF raises events and run the handlers. The handlers add command to the PendingCommands variable; those commands include information about the user activity and the program sends them to the SERVER when it initiate a request; if the program sees that a user activity required an event on the SERVER it initiates a request. For example the function Checkbox_P_Click is a handler for the OnClick event of a checkbox (ATML Broeser WPF\ATMLObject\ATMLCheckbox.vb line 661 in ATM L_Broeser_WPF.txt); when the user checks on the checkbox the program adds a command to the PendingCommands for informing the SERVER that the user click on checkbox; the command includes the unique id of the checkbox and the current value; and if there is a CheckChanged handler on the solution (SERVER) for that checkbox the program initiates a new request.

The program initiates a timer the sends empty request to the SERVER every 60 seconds in order of keeping the server session alive. (MainClass.vb line 4577 in ATML_Broeser_WPF.txt).

Example of SOLUTION with database

The file “CRM.txt” includes the source files of an example of a solution with a database.

“CRM” developed with ATML.Net.DLL and can be run with the CSA DRIVER.

It meant to demonstrate the advantages and the power of CSA.

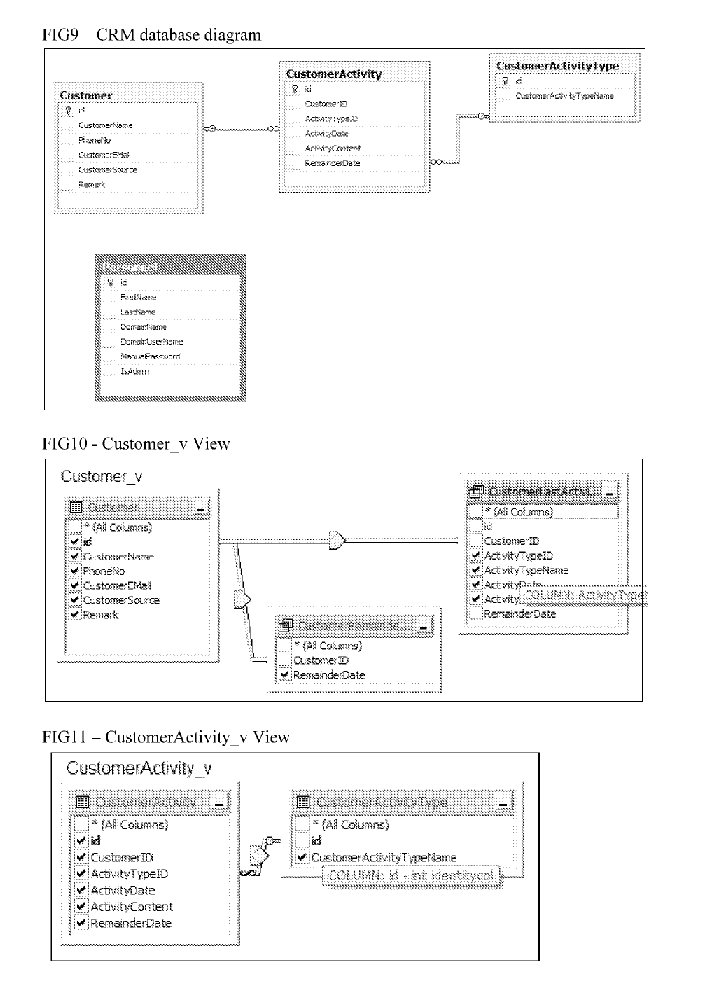

FIG. 9 shows the Tables and the Fields on the CRM Datanase

FIG. 10 shows the Customer_v View on the database

FIG. 11 Shows the CustomerActivity_v view on the database.

With CSA programmers can work with objects that perform the whole task as a single unit; without CSA it is very difficult to develop objects of this kind because any single task is separated into two programs: client side and server side.

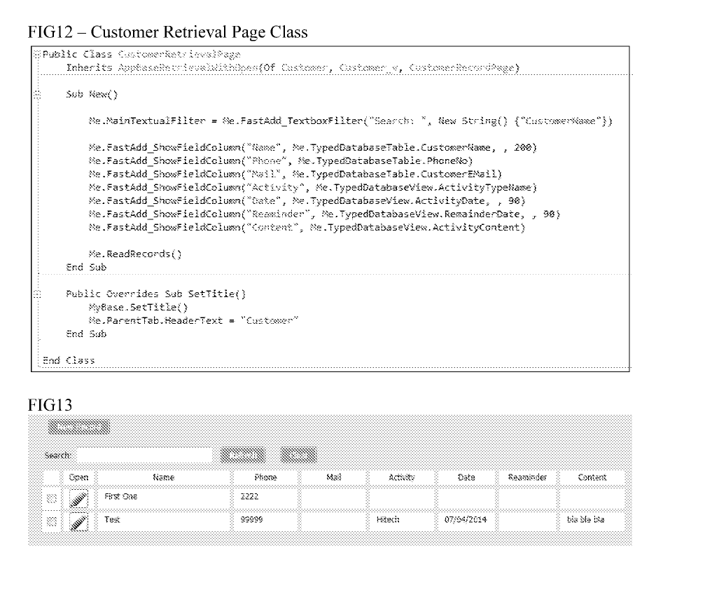

For example, the class CustomerRetrievalPage (FIG. 12 and CRM\Pages\CustomerRetrievalPage.vb) demonstrates the use of RetrievalGrid object. RetrievalGrid is a UI Element that represents a search page where user can search records from a database object Table or View.

With CustomerRetrievalPage the programmer defines the data source, the search parameters and the columns on the displayed table. The object does the rest.

FIG. 13 is a screenshot of the page of CustomerRetrieval class.

CutomerRetrivalPage inherits from AppBaseReyrievalWithOpen (CRM\BasePages\AppBaseReyrievalWithOpen.vb) that inherits from AppBaseRetrievalGrid (CRM\BasePages\AppBaseReyrievalGrid.vb) that inherits from RetrievakGrid (ATML.Net\UpperControls\Retrieval\Retrieval\RerievalGridGeneric.vb)

The RetrievalGrid class is only an example, the folder “ATML.Net/UpperControls” in “ATML_Net.txt” includes many examples of high level UI Elements for different purposes; and any programmer can develop high level object as well.

In addition the solution can be used from any platform, and it is very simple to update new versions; new versions are updated on the server only.

Having described my invention, I claim:

1. A System that includes server side component and equivalent client side components; client side component for each platform; the server side component allows programmers to develop a solution that includes UI Elements and commands.
The solution is hosted on a server. The client components allow users to run the solution.
The solution communicates with the client components; where the server runs the solution and sends to a client commands that are related to UI Elements and other commands that should be executed on the client; the client implements the user interface graphically and executes the other commands and sends to the server information about the user activity.
